(19) United States
(12) Patent Application Publication
(10) Pub. No.: US 2026/0308285 A1
(43) Pub. Date: Oct. 8, 2026

(54) METHOD FOR PRODUCING POLYMERS WITH LOW RESIDUAL ACRYLAMIDE AND APPLICATION THEREOF

(71) Applicant: BL TECHNOLOGIES, INC., Minnetonka, MN (US)

(72) Inventors: Ruslan Guliyev, Minnetonka, MN (US); Greg Kaplan, Minnetonka, MN (US); Edward Urankar, Minnetonka, MN (US); Lisa Spagnola, Minnetonka, MN (US); Sergio Anis, Minnetonka, MN (US)

(21) Appl. No.: 19/485,133

(22) PCT Filed: Apr. 12, 2024
(86) PCT No.: PCT/US2024/024388

§ 371 Date: Nov. 17, 2025

Related U.S. Application Data
(60) Provisional application No. 63/503,046, filed on May 18, 2023.

(51) Int. Cl. C08F 6/00; C08F 122/38; C08F 222/38

(52) U.S. Cl. CPC C08F 6/006; C08F 122/38; C08F 222/38

(57) ABSTRACT

Provided herein are methods of reducing a residual acrylamide monomer content present in an acrylamide-based polymer emulsion comprising adding a treatment agent to the acrylamide-based polymer emulsion. Further provided herein are methods of preparing an acrylamide-based emulsion polymer comprising polymerizing a mixture comprising acrylamide monomers to form an acrylamide-based polymer emulsion; and adding a treatment agent to the acrylamide-based polymer emulsion.

### CROSS REFERENCE TO RELATED APPLICATIONS

This application claims priority to U.S. Provisional Patent Application No. 63/503,046, filed on May 18, 2023, which is incorporated by reference herein in its entirety.

### BACKGROUND

The disclosed technology provides for methods for scavenging residual toxic acrylamide monomer present in acrylamide-based polymer and copolymer emulsions. More specifically, the disclosed technology provides for methods for scavenging residual toxic acrylamide monomer present in acrylamide-based polymer emulsions by adding a treatment agent to the polymer emulsion to produce acrylamide-based emulsion polymers with low residual levels of unreacted acrylamide monomer.

Polyacrylamides and their copolymers can be synthesized as high molecular weight polymers using emulsion techniques. These polymers are employed in several industries, ranging from oil fields, fracking and transporting (friction reducers) to water and/or wastewater treatment (flocculants). These polymers are also employed to enhance oil recovery, in soil conditioning, as thickening agents and super adsorbing polymers, and in paper making. Acrylamide molecules are the key monomer in building up these high molecular weight copolymers and provide significant advantages in terms of cost, reactivity, and availability.

Despite its high reactivity, traces of unreacted acrylamide monomer may often be found in final polyacrylamide emulsion products. This raises concerns as acrylamide monomer has been shown to possibly be carcinogenic and/or mutagenic. More specifically, acrylamide is known as a potential occupational carcinogen by U.S. government agencies and classified as a Group 2A carcinogen by the IARC.

According to the WHO, the most important source of drinking water contamination by acrylamide is the use of polyacrylamide flocculants that contain residual acrylamide monomer. Replacing acrylamide with other relatively benign acryl and/or vinyl monomers would likely be a cumulative solution to such problem. However, the significantly lower cost and higher performance of acrylamide-based polymers make this a difficult task to address. Additionally, to the best of our knowledge, there are a limited number of monomers that can polymerize as effectively as acrylamide while maintaining some performance attributes when substituted in the emulsion polymers. However, compared to the acrylamide-based polymers, these polymers fall short in terms of efficacy and are usually insufficient for an industrial application. As such, it can be concluded that there is a lack of potential monomers to replace acrylamide.

Thus, what is needed in the art is an effective and more cost-efficient residual acrylamide monomer removal process.

### SUMMARY

The disclosed technology provides for a method for scavenging residual acrylamide monomer present in acrylamide-based emulsion polymer products by reacting such unreacted acrylamide monomers with a treatment agent in order to form less toxic chemistries.

Various aspects of the disclosed technology relate to a method of reducing a residual acrylamide monomer content present in an acrylamide-based polymer emulsion comprising adding a treatment agent to the acrylamide-based polymer emulsion.

In various aspects, the treatment agent is added after polymerization of the acrylamide-based polymer.

In various aspects, the treatment agent is added during polymerization of the acrylamide-based polymer.

Various aspects of the disclosed technology additionally relate to a method of preparing an acrylamide-based emulsion polymer comprising polymerizing a mixture comprising acrylamide monomers to form an acrylamide-based polymer emulsion; and adding a treatment agent to the acrylamide-based polymer emulsion.

In various aspects, the treatment agent may be selected from a group that includes amines, thiols, and mixtures thereof.

In various aspects, the acrylamide-based polymer comprises polyacrylamide, and/or acrylamide copolymers.

Various aspects of the disclosed technology further relate to acrylamide-based polymer emulsions and products prepared using the methods disclosed herein.

### BRIEF DESCRIPTION OF THE FIGURES

FIG. 1 illustrates the efficacy of an embodiment of the acrylamide-based emulsion polymer of the disclosure on clay settling.

FIG. 2 illustrates the efficacy of another embodiment of the acrylamide-based emulsion polymer of the disclosure on clay settling.

### DETAILED DESCRIPTION

The disclosed technology provides for methods of scavenging residual toxic acrylamide monomers present in acrylamide-based emulsion polymers. More specifically, the disclosed technology provides for methods for scavenging residual toxic acrylamide monomer present in acrylamide-based polymer emulsions by adding a treatment agent to the acrylamide-based polymer emulsion to produce acrylamide-based emulsion polymers with low residual levels of unreacted acrylamide monomer.

Although emulsion polymerization is generally a high-yield process, any trace of unreacted acrylamide poses a pollution threat due to its toxicity. Regulations have set threshold values for residual acrylamide levels in acrylamide-based emulsion products, depending on the application. Current methods practiced today use addition of free radical generator/initiators (burnout) at the end of the polymerization process to attempt to incorporate all of the acrylamide monomer into polymeric product. However, this introduces considerable byproducts (salts) into the process and has proven to not be capable of easily reaching the residual acrylamide levels. Burn-outs also require longer reaction times, which adds to the cost and efficacy of the overall process. The methods of the disclosure describe the use of an alternative high yield reaction capable of converting residual acrylamide levels to targeted levels below regulatory thresholds without affecting performance attributes.

As used herein, the term “acrylamide-based polymer” may be understood to mean any polymer comprising acrylamide monomer, including, for example, high-molecular weight polyacrylamides.

As used herein, the term “treatment agent” may be understood to mean any compound capable of reacting with residual acrylamide. Exemplary compounds may include compounds capable of targeting one or more reaction sites of an acrylamide monomer.

In various aspects, the disclosed technology involves methods of reducing the residual acrylamide monomer content present in an acrylamide-based polymer emulsion and methods of preparing acrylamide-based emulsion polymers with a reduced residual acrylamide monomer content.

In various aspects, the methods of the disclosure may include adding a treatment agent to the acrylamide-based polymer emulsion. In some aspects, the treatment agent may be added during or after polymerization of the acrylamide-based polymer. In other aspects, the treatment agent may be any compound capable of targeting one or more reaction sites of an acrylamide monomer. In some aspects, suitable treatment agents may include one or more compounds capable of targeting the double bond or amide linkages of an acrylamide monomer.

In various aspects, the methods of the disclosure may include adding the treatment agent in an amount of about 0.1% to about 10% by weight of the acrylamide-based polymer emulsion. In some aspects, the methods of the disclosure may include adding the treatment agent in an amount of about 0.1%, 0.5%, 1%, 1.5%, 2%, 2.5%, 3%, 3.5%, 4%, 4.5%, 5%, 5.5%, 6%, 6.5%, 7%, 7.5%, 8%, 8.5%, 9%, 9.5% or 10% by weight of the acrylamide-based polymer emulsion, or any amount in between these amounts, or from about 0.1% to about 5% by weight of the acrylamide-based polymer emulsion, or from about 0.5% to about 2% by weight of the acrylamide-based polymer emulsion, or from about 0.5% to about 1% by weight of the acrylamide-based polymer.

In various aspects, the methods of the disclosure may include adding a treatment agent to the acrylamide-based polymer emulsion. In some aspects, the treatment agent may be added during or after polymerization of the acrylamide-based polymer. In some aspects, suitable treatment agents may include amines, thiols, or mixtures or salts thereof. In some aspects, suitable treatment agents may include small molecule ethyleneamines, polymers and oligomers comprising amine and/or thiol/carbamate/thiolate functionalities, amine functionalized styrene resins, resins with pendant amine or mercaptan functionalities, or mixtures thereof. In some aspects, suitable amines may include ammonia, hydrazine, hydroxylamine, substituted amines, methyl amine, dimethylamine, mono-ethanolamine, cysteamine, ethylene diamine, DETA, TETA, TEPA, PEHA, and mixtures of higher amines.

In various aspects, the acrylamide-based polymer emulsion used in the methods of the disclosure may be a neutral polyacrylamide-based polymer emulsion, a cationic polyacrylamide-based emulsion polymer, or an anionic polyacrylamide-based emulsion polymer.

In various aspects, the disclosed technology provides acrylamide-based polymer emulsions prepared according to the methods of the disclosure. In various aspects, the acrylamide-based (co) polymer emulsions of the disclosure include neutral, cationic, or anionic polyacrylamides. In some aspects, the acrylamide-based polymer emulsions include a residual acrylamide monomer content below a regulatory threshold value. In some aspects, the acrylamide-based polymer emulsions include at least less than 500 ppm, preferably less than 99 ppm of residual acrylamide monomer.

In various aspects, the acrylamide-based polymer emulsions of the disclosure may be used in various applications. In various aspects, the acrylamide-based polymer emulsions may be used to treat wastewater, enhance oil recovery, condition soil, as thickening agents and super adsorbing polymers, and in paper making.

In various aspects the disclosed technology also provides products comprising the acrylamide-based polymer emulsions of the disclosure. In some aspects, suitable products include friction reducers, hydraulic fracturing fluid additives, and flocculants. In other aspects, suitable products include any product that can include therein a acrylamide-based polymer emulsion having a low residual acrylamide monomer content.

### EXAMPLES

The present technology will be further described in the following examples, which should be viewed as being illustrative and should not be construed to narrow the scope of the disclosed technology or limit the scope to any particular embodiments.

### General Procedures for Examples 1-5

To a known amount of acrylamide-based neutral (Polyacrylamide/PAM) or anionic (Polyacrylamide-co-acrylate) emulsion polymers was added 0.5% to 2% (wt/wt) of a treatment agent as its water solution over 30 minutes at 30° C. and/or 45° C. The mixture was then mixed for an additional 2 hours. Analysis of residual acrylamide after mixing for 2 hours determines the effective quantity of the treatment agent. The reaction is continued by adding more treatment agent until the desired acrylamide levels are achieved.

### Control 1 for Examples 1-3: Polyacrylamide (PAM) Emulsion Product—Neutral Polymer

### Example 1

Control 1 containing 710 ppm AM (acrylamide monomer) was treated with 1% EDA (ethylene diamine).

### Example 2

Control 1 containing 710 ppm AM was treated with 1% MEA (monoethanol amine).

### Example 3

### Efficacy of Polymers (Before and After Treatment) Measured by Clay Settling

A 2% clay slurry was prepared with 0.1% sodium chloride, and 0.1% MgCl₂ in water. The pH was adjusted to 7 with IN NaOH. 250 mL of the slurry was placed in a graduated cylinder and mixed. Inverted polymer of Examples 1 and 2 were dosed into the cylinder and mixed. The time for the slurry to settle over a 60 mm increment was measured. The rate was then converted by dividing 60 by the number of seconds to settle.

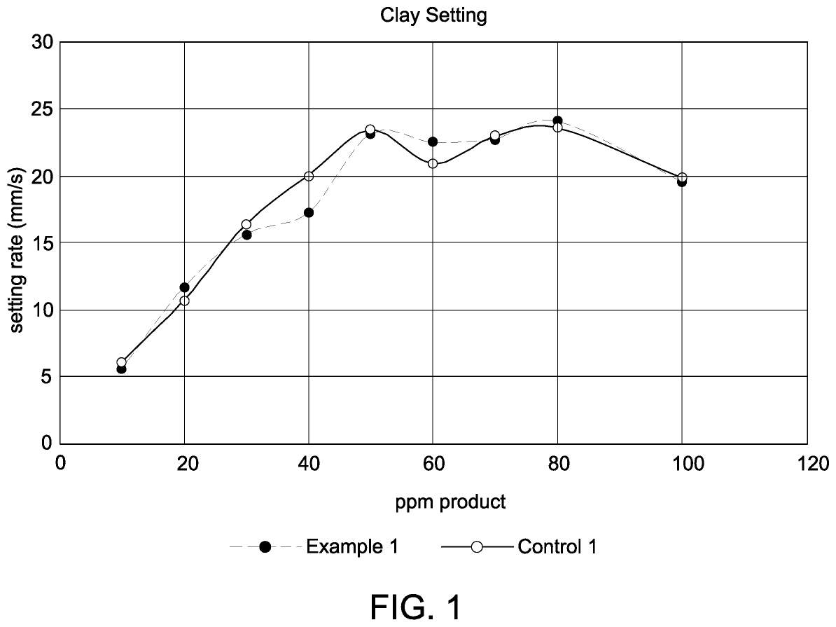

A scavenged sample of Example 1 was compared to Control 1 (PAM) to determine if treatment affects the efficacy of the final emulsion polymers. As shown in FIG. 1, the results show that EDA treatment does not change the efficacy of the polymers.

### Control 2 for Example 4: Anionic Emulsion Polymer of Poly(acrylic acid-co-acrylamide) (PAA-co-AM) 30:70

### Example 4

Control 2 containing 680 ppm of AM was treated with 1% EDA.

The amount of AM in Examples 1, 2 and 4 after treatment is shown below in Table 1.

TABLE 1
Treatment of neutral PAM emulsion and anionic emulsion polymer with EDA

| | | Initial | After Treatment | | | |
|---|---|---|---|---|---|---|
| Sample # | Description | Acrylamide | at: | | | |
| Control 1 | Polyacrylamide (PAM) | 710 ppm | 30 | °C | 45 | °C |
| (PAM) | emulsion | | | | | |
| Example 1 | PAM + 1% (wt/wt) EDA | 710 ppm | <5 | ppm | <5 | ppm |
| Example 2 | PAM + 1% (wt/wt) MEA | 710 ppm | 441 | ppm | 402 | ppm |
| Control 2 | Poly-Acrylate-co- | 680 ppm | | | | |
| (PAA-co-AM) | Acrylamide | | | | | |
| Example 4 | PAA-co-AM + 1% (wt/wt) | 680 ppm | 77 | ppm | 63 | ppm |
| | EDA | | | | | |

### Example 5

### Efficacy of Polymers (Before and After Treatment) Measured by Clay Setting

A 2% clay slurry was prepared with 0.1% sodium chloride, and 0.1% MgCl₂ in water. The pH was adjusted to 7 with IN NaOH. 250 mL of the slurry was placed in a graduated cylinder and mixed. Inverted polymer of Example 4 was dosed into the cylinder and mixed. The time for the slurry to settle over a 60 mm increment was measured. The rate was then converted by dividing 60 by the number of seconds to settle.

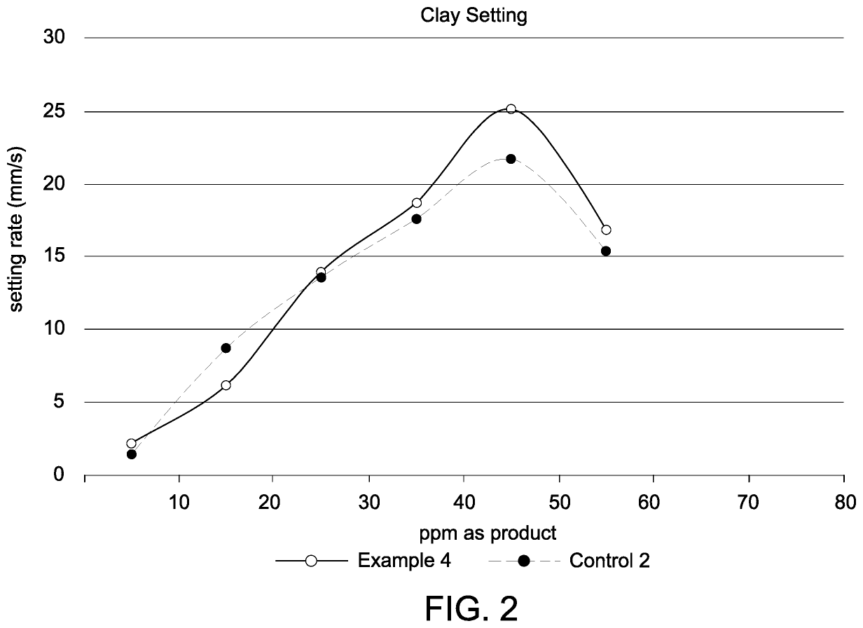

A scavenged sample of Example 4 was compared to Control 2 (PAA-co-AM) to determine if treatment affects the efficacy of the final emulsion polymers. As shown in FIG. 2, the results show that EDA treatment does not change the efficacy of the polymers.

### Control 3 for Examples 6-22: Cationic Polymer of Poly-acrylamide-co-acryloyloxyethyltrimethyl Ammonium Chloride (PAM-co-AETAC) 58:42 mole %

### Example 6

Control 3 containing 664 ppm of AM was treated with 1% EDA for 1 hour at 45° C.

### Example 7

Control 3 containing 664 ppm of AM was treated with 2% EDA for 1 hour at 45° C.

### Example 8

Control 3 containing 664 ppm of AM was treated with 5% Trisamine Polystyrene.

### Example 9

Control 3 containing 664 ppm of AM was treated with 1% EDA

hydrochloride salt solution.

### Example 10

Control 3 containing 664 ppm of AM was treated with 1% MEA hydrochloride salt solution.

### Example 11

Control 3 containing 664 ppm of AM was treated with 1% MEA.

### Example 12

Control 3 containing 664 ppm of AM was treated with 2% MEA.

The amount of AM in Examples 6-12 after treatment is shown below in Table 2.

TABLE 2
Treatment of cationic poly-acrylamide-
co-aetac with various treatment agents

| | | Acrylamide |
|---|---|---|
| Samples | Description | ppm |
| Control 3 | Poly-acrylamide-co-aetac | 664 |
| (PAM-co- | | |
| AETAC) | | |
| Example 6 | +1% EDA 1 hr at 45 C | <5 |
| Example 7 | +2% EDA 1 hr at 45 C | <5 |
| Example 8 | +5% Trisamine Polystyrene | 517 |
| Example 9 | +1% EDA hydrochloride salt solution | 23 |
| Example 10 | +1% MEA hydrochloride salt solution | 91 |
| Example 11 | +1% MEA | 154 |
| Example 12 | +2% MEA | 28 |

### Example 13

Control 3 containing 803 ppm of AM was treated with 1% polyethyleneimine (PEI) low molecular weight (MW).

### Example 14

Control 3 containing 803 ppm of AM was treated with 0.5% PEI low MW.

### Example 15

Control 3 containing 803 ppm of AM was treated with 0.25% PEI low MW.

### Example 16

Control 3 containing 803 ppm of AM was treated with 1% EDA.

### Example 17

Control 3 containing 803 ppm of AM was treated with 2% EDA.

### Example 18

Control 3 containing 803 ppm of AM was treated with 1% MEA.

### Example 19

Control 3 containing 803 ppm of AM was treated with 0.5% PEI high MW.

### Example 20

Control 3 containing 803 ppm of AM was treated with 0.25% PEI high MW.

### Example 21

Control 3 containing 803 ppm of AM was treated with 0.125% PEI high MW.

The amount of AM in Examples 13-21 after treatment is shown below in Table 3.

TABLE 3
Treatment of cationic poly-acrylamide-
co-aetac with various treatment agents

| | | Acrylamide |
|---|---|---|
| Samples | Description | ppm |
| Control 3 | Poly-acrylamide-co-aetac | 803 |
| (PAM-co-AETAC) | (58:42 mole %) sample | |
| Example 13 | +1% PEI low MW | 163 |
| Example 14 | +0.5% PEI low MW | 386 |
| Example 15 | +0.25% PEI low MW | 610 |
| Example 16 | +1% EDA | 18 |
| Example 17 | +2% EDA | 5 |
| Example 18 | +1% MEA | 141 |
| Example 19 | +0.5% PEI high MW | 496 |
| Example 20 | +0.25% PEI high MW | 630 |
| Example 21 | +0.125% PEI high MW | 637 |

While embodiments of the disclosed technology have been described, it should be understood that the present disclosure is not so limited and modifications may be made without departing from the disclosed technology. The scope of the disclosed technology is defined by the appended claims, and all devices, processes, and methods that come within the meaning of the claims, either literally or by equivalence, are intended to be embraced therein.

1. A method of reducing a residual acrylamide monomer content present in an acrylamide-based polymer emulsion comprising adding a treatment agent to the acrylamide-based polymer emulsion, wherein the treatment agent comprises amines, amine salts, thiols, or mixtures thereof, and wherein the treatment agent is added in an amount of about 0.1% to about 10% by weight of the acrylamide-based polymer emulsion.

2. The method of claim 1, wherein the treatment agent is added after polymerization of the acrylamide-based polymer.

3. The method of claim 1, wherein the treatment agent is added during polymerization of the acrylamide-based polymer.

4. (canceled)

5. (canceled)

6. The method of claim 1, wherein the treatment agent is selected from the group consisting of ammonia, hydrazine, hydroxylamine, substituted amines, ethyleneamines, and their salts, polymers comprising amine and/or thiol/carbamate/thiolate functionalities, amine/thiol functionalized styrene resins, resins with pendant amine or mercaptan functionalities, and mixtures and salts thereof.

7. The method of claim 6, wherein the treatment agent is an ethylene-diamine or ethylene diamine salt.

8. The method of claim 1, wherein the acrylamide-based polymer emulsion comprises a polyacrylamide, and/or acrylamide copolymers.

9. An acrylamide-based polymer emulsion prepared according to the method of claim 1.

10. The acrylamide-based polymer emulsion of claim 9, wherein the acrylamide-based polymer emulsion comprises a residual acrylamide monomer content of less than 500 ppm.

11. A product comprising the acrylamide-based polymer emulsion of claim 9.

12. The product of claim 11, wherein the product comprises a friction reducer, hydraulic fracturing and petroleum extraction fluid additive, thickening agent, or a flocculant.

13. A method of preparing an acrylamide-based emulsion polymer comprising:
polymerizing a mixture comprising acrylamide monomers to form an acrylamide-based polymer emulsion; and
adding a treatment agent to the acrylamide-based polymer emulsion,
wherein the treatment agent comprises amines, amine salts, thiols, or mixtures thereof, and
wherein the treatment agent is added in an amount of about 0.1% to about 10% by weight of the acrylamide-based polymer emulsion.

14. The method of claim 13, wherein the treatment agent is added after polymerization of the mixture comprising acrylamide monomers.

15. The method of claim 13, wherein the treatment agent is added during polymerization of the mixture comprising acrylamide monomers.

16. (canceled)

17. (canceled)

18. The method of claim 13, wherein the treatment agent is selected from the group consisting of ammonia, hydrazine, hydroxylamine, substituted amines, ethyleneamines, and their salts, polymers comprising amine and/or thiol/carbamate/thiolate functionalities, amine/thiol functionalized styrene resins, resins with pendant amine or mercaptan functionalities, and mixtures and salts thereof.

19. The method of claim 18, wherein the treatment agent is an ethylene-amine.

20. The method of claim 13, wherein the acrylamide-based polymer emulsion comprises a polyacrylamide, and/or acrylamide copolymers.

21. An acrylamide-based emulsion polymer prepared according to the method of claim 13.

22. The acrylamide-based emulsion polymer of claim 21, wherein the acrylamide-based polymer emulsion comprises a residual acrylamide monomer content of less than about 500 ppm.

23. A product comprising the acrylamide-based emulsion polymer of claim 21.

24. The product of claim 23, wherein the product comprises a friction reducer, hydraulic fracturing and petroleum extraction fluid additive, thickening agent or a flocculant.
